(19) United States
(12) Patent Application Publication
(10) Pub. No.: US 2023/0286049 A1
(43) Pub. Date: Sep. 14, 2023

(54) DEVICE AND METHOD FOR CONTROLLING SIZE OF MOLTEN POOL IN WIRE AND ARC ADDITIVE MANUFACTURING PROCESS

(71) Applicant: Beijing University of Technology, Beijing (CN)

(72) Inventors: Fan JIANG, Beijing (CN); Guokai ZHANG, Beijing (CN); Bin XU, Beijing (CN); Debao LI, Beijing (CN); Shujun CHEN, Beijing (CN)

(73) Assignee: Beijing University of Technology, Beijing (CN)

(21) Appl. No.: 18/119,851

(22) Filed: Mar. 10, 2023

(30) Foreign Application Priority Data
Mar. 12, 2022 (CN) 202210239830.4

(51) Int. Cl. B22F 10/322; B22F 10/22; B22F 12/70; B22F 12/00; B22F 12/90

(52) U.S. Cl. CPC B22F 10/322; B22F 10/22; B22F 12/70; B22F 12/224; B22F 12/222; B22F 12/90; B33Y 10/00

(57) ABSTRACT

A device and a method for controlling a size of a molten pool in a wire and arc additive manufacturing process are provided. The device includes additive manufacturing equipment, a connecting device, bilateral gas flow devices and a CCD camera. By adjusting the connecting device, the bilateral gas flow devices and a welding gun have proper relative positions. The CCD camera is clamped on a rear side of the welding gun and matched with a proper optical filter to detect size information of the molten pool. In the additive manufacturing process, the bilateral gas flow devices and the welding gun keep moving synchronously, welding wires are conveyed to a designed position of a deposited layer by a wire feeding device, and bilateral gas flows can directly and synchronously act on a melting region. A flow controller is adjusted in real time according to the size of the molten pool.

### CROSS REFERENCE TO THE RELATED APPLICATIONS

This application is based upon and claims priority to Chinese Patent Application No. 202210239830.4, filed on Mar. 12, 2022, the entire contents of which are incorporated herein by reference.

### TECHNICAL FIELD

The present disclosure belongs to the field of additive manufacturing, and particularly relates to a device and method for controlling a size of a molten pool in a wire and arc additive manufacturing process.

### BACKGROUND

An additive manufacturing technology, also known as “3D printing” and “rapid prototyping”, is a process of manufacturing solid parts by the layer-by-layer accumulation of materials based on dispersion and accumulation principles according to three-dimensional forms of the parts. In the field of metal additive manufacturing, heat sources adopted for the rapid prototyping technology mainly include laser, electron beams and arcs, and a wire and arc additive manufacturing technology has received extensive attention due to its advantages such as high material utilization rate, wide range and low cost. However, in the wire and arc additive manufacturing process, deposited layers will have the problems such as collapse thereof and low forming precision with gradual increase of heat accumulation.

Thus, some researchers proposed a composite additive manufacturing technology based on a clamping restraint to solve the above problems. Structure properties and forming precision of formed parts can be improved on the premise of not reducing the number of the deposited layers. In the related research in the prior art, as for the forming precision, by means of a clamping auxiliary forming device for two sides of a molten pool in an additive manufacturing process and a method proposed by a Chinese patent CN112916874A, surface smoothness of a side wall of a deposited layer and size precision in a width direction can be improved to a certain degree under the action of a clamping restraint of clamping components. However, as the device directly acts on an outer wall of the deposited layer-based molten pool in a semi-molten and semi-solidified state, non-uniform property distribution inside the whole deposited layer will be caused. Moreover, as rollers of the device make direct contact with the molten pool for a long time, loss of the rollers will be caused, resulting in shortening service life and increasing use cost. Thus, a device and method for controlling a size of a molten pool in a wire and arc additive manufacturing process are provided, bilateral gas flows are applied to the side wall of the deposited layer in the additive manufacturing process, a flow controller is adjusted in real time according to size information of the molten pool detected by a charge coupled device (CCD) camera to control flow of the bilateral high-speed gas flows, and deformation pressure and a flexible supporting effect applied by the bilateral gas flows to side walls of the molten pool are changed, so that the size of the molten pool is restrained. Therefore, a sample piece with the excellent morphology, good properties and precise forming size of the deposited layer is obtained.

### SUMMARY

In order to solve the above technical problems, the present disclosure provides a device and method for controlling a size of a molten pool in a wire and arc additive manufacturing process, mainly meeting different requirements of wire and arc additive manufacturing.

The technical solutions of the present disclosure are as follows:

Provided are a device and method for controlling a size of a molten pool in a wire and arc additive manufacturing process. The device includes additive manufacturing equipment, a connecting device and bilateral gas flow devices. The additive manufacturing equipment includes a welding gun, a welding power source, a gas cylinder II, a wire feeding device and a wire feeding device connecting plate. Welding wires are conveyed to a designed position of a deposited layer by the wire feeding device, molten drops are bonded to a substrate under the action of arcs, and a member is formed on the designated substrate by deposition; wherein a heat source in the additive manufacturing process is supplied by the welding power source connected to the welding gun; the wire feeding device is connected to a connecting block on the welding gun by the wire feeding device connecting plate, so that the welding gun and the wire feeding device move synchronously; and a CCD camera is clamped on a rear side of the welding gun and matched with a proper optical filter to detect size information of the molten pool.

The connecting device includes the connecting block, z-axis position adjusting devices, y-axis position adjusting devices, x-axis position adjusting devices and deflection angle position adjusting devices; the connecting block is fixed to the welding gun and serves as a reference structural part for adjusting relative positions of the bilateral gas flow devices and the welding gun; and the welding gun, the connecting block, the z-axis position adjusting devices, the y-axis position adjusting devices, the x-axis position adjusting devices, the deflection angle position adjusting devices and the bilateral gas flow devices are sequentially connected and combined by bolts.

The bilateral gas flow devices are connected to the connecting device, and precise adjustment of the relative positions of the bilateral gas flow devices and the welding gun is achieved by adjusting the connecting device; an interval between the bilateral gas flow devices can be adjusted by adjusting the connecting device, so that forming size precision of a sample piece is controlled; and in the deposition forming process, bilateral high-speed gas flows apply pressure to side walls of the molten pool, so as to realize a flexible supporting effect on the deposited layer, flow and solidification of the deposited layer are adjusted by changing gas types and temperatures, and precise control over a size of the formed sample piece is achieved.

The CCD camera is clamped on the rear side of the welding gun and matched with the proper optical filter to detect the size information of the molten pool. A flow controller is adjusted in real time according to the size information of the molten pool detected by the CCD camera to control flow of the bilateral high-speed gas flows, and deformation pressure and the flexible supporting effect applied by the bilateral high-speed gas flows to the side walls of the molten pool are changed, so that the size of the molten pool is restrained, and size precision of the formed sample piece is improved.

Connecting parts of the z-axis position adjusting devices, the y-axis position adjusting devices, the x-axis position adjusting devices and the deflection angle position adjusting devices are provided with size scales, thereby achieving precise adjustment of the relative positions of the bilateral gas flow devices and the welding gun.

The welding wires are stainless steel or aluminum alloy welding wires.

Gases, used for an interior of the welding gun and two sides of the deposited layer, in a gas cylinder I and the gas cylinder II are both inert gases.

Wire and arc additive manufacturing manners include gas metal arc welding (GMAW), gas tungsten arc welding (GTAW) and plasma arcs.

A material of the bilateral gas flow devices needs to withstand a temperature that is 300° C. or above higher than the temperature of the molten pool in the deposition forming process.

Connecting parts of the z-axis position adjusting devices, the y-axis position adjusting devices, the x-axis position adjusting devices and the deflection angle position adjusting devices are provided with size scales, thereby achieving precise adjustment of the relative positions of the bilateral gas flow devices and the welding gun.

A method for controlling a size of a molten pool in a wire and arc additive manufacturing process implemented by the above device, includes the following steps:

step 1: adjusting the connecting device to enable a horizontal interval between gas flow nozzles of the bilateral gas flow devices to be 1 mm greater than a needed width of the deposited layer and an included angle between the gas flow nozzles and enable a horizontal position to be 15°, and fastening the connecting device after position adjusting, so as to enable the bilateral gas flow devices and the welding gun keep moving synchronously in a certain relative position relationship;

step 2: starting the additive manufacturing equipment to be matched with a three-dimensional movement mechanism under the synergistic action of the welding gun, the connecting device and the welding power source for additive manufacturing, adjusting and controlling flow of the bilateral high-speed gas flows in real time according to the size of the molten pool detected by the CCD camera in a deposition forming process, changing the deformation pressure and the flexible supporting effect applied by the bilateral gas flows to the side walls of the molten pool, so as to restrain the size of the molten pool, and meanwhile adjusting flow and solidification of the deposited layer by changing gas types and temperatures, to form the sample piece with an excellent morphology and a precise size of the deposited layer;

step 3: returning to an initial position, and lifting the welding gun to a certain height; and

step 4: repeating step 2 and step 3 for continuous reciprocating deposition, and finally forming the needed member.

The present disclosure has the following beneficial effects:

(1) Compared with the prior art, forming is achieved under the assistance of a flexible gas support, so that contact between a mechanical rigid support and the deposited layer is avoided, thereby reducing the defects such as loss of the additive device and cracking of the deposited layer.

(2) Compared with the prior art, the present disclosure can adjust and control the flow of the bilateral high-speed gas flows in real time according to the size of the molten pool detected by the CCD camera, so as to change the deformation pressure and the flexible supporting effect applied by the bilateral gas flows to the side walls of the molten pool, thereby restraining the size of the molten pool.

(3) Compared with the prior art, the present disclosure can adjust flow and solidification of the deposited layer by changing the gas types and temperatures, thereby improving forming quality.

### BRIEF DESCRIPTION OF THE DRAWINGS

FIG. 1 is a schematic structural diagram of a device for controlling a size of a molten pool in a wire and arc additive manufacturing process, adopting a paraxial wire feeding manner.

FIG. 2 is a schematic diagram of a connecting device and bilateral gas flow devices, wherein z-axis position adjusting devices, y-axis position adjusting devices, x-axis position adjusting devices and deflection angle position adjusting devices are sequentially connected and combined by bolts, the deflection angle position adjusting devices are connected to the bilateral gas flow devices, the z-axis position adjusting devices are connected to a connecting block, and the bilateral gas flow devices are connected to a gas cylinder I.

In the figures: 1. Welding gun; 2. Connecting device; 2-1. Connecting block; 2-2. z-axis position adjusting device; 2-3. y-axis position adjusting device; 2-4. x-axis position adjusting device; 2-5. Deflection angle position adjusting device; 3. CCD camera; 4. Member; 5. Substrate; 6. Bilateral gas flow device; 7. Gas cylinder I; 8. Wire feeding device; 9. Wire feeding device connecting plate; 10. Gas cylinder II; 11. Welding power source.

### DETAILED DESCRIPTION OF THE EMBODIMENTS

In order to further understand the contents, features and effects of the present disclosure, the following embodiment is listed and described in detail below with reference to the accompanying drawings:

The basic thought of the present disclosure is as follows: flow of bilateral high-speed gas flows is adjusted and controlled in real time according to a size of a molten pool detected by a CCD camera, deformation pressure and a flexible supporting effect applied by the bilateral gas flows to side walls of the molten pool are changed, so as to restrain the size of the molten pool, and meanwhile flow and solidification of a deposited layer are adjusted by changing gas types and temperatures, to form a sample piece with an excellent morphology and a precise size of the deposited layer.

### Embodiment 1

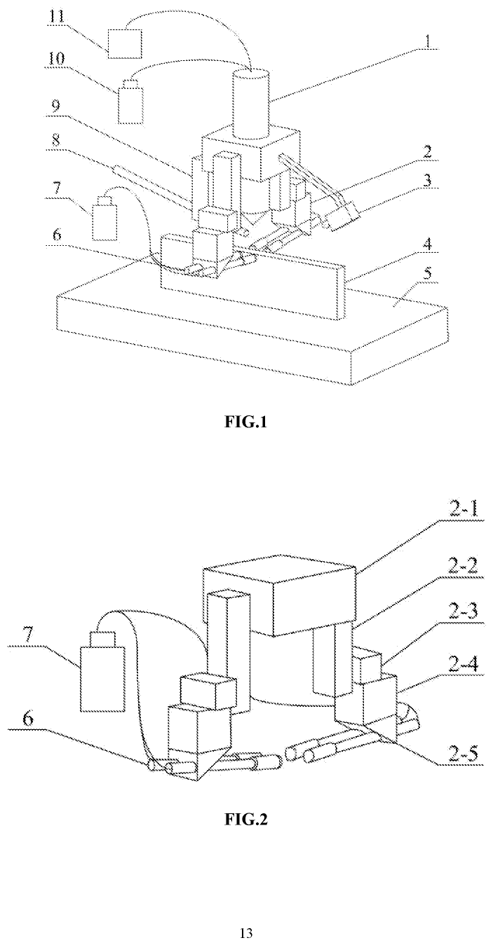

An illustration is made by taking a plasma arc additive manner of manufacturing an aluminum alloy thin-wall part with a deposited layer being 4 mm wide as an example, as shown in FIG. 1, a paraxial wire feeding manner is adopted, a welding power source of wire and arc additive manufacturing is a polarity-variable plasma arc power source, a three-dimensional movement mechanism is used to drive a plasma welding gun to move, gas flow nozzles are cylindrical nozzles, and a method specifically includes the following steps:

Step 1: a surface of a 5A06 aluminum alloy substrate is ground by abrasive paper, so as to remove an oxidation film thereon, the substrate is put on a surface of a workbench, ER4043 aluminum alloy wires are put into a wire feeder, the wire feeder power source is turned on, a wire feeding speed is set at 4 m/min, ionic gas flow is set at 1.4 L/min, and shielding gas flow is set at 15 L/min. The polarity-variable plasma arc power source is turned on, currents at an EN stage of plasma arcs are set at 60 A, and currents at an EP stage are set at 70 A;

step 2: relative positions of the plasma welding gun and the additive substrate are adjusted by a three-dimensional movement mechanism controller, so that the plasma welding gun is located 8 mm above the substrate;

step 3: firstly, the gas flow nozzles are located 6 mm away from the plasma welding gun in a y direction by adjusting y-axis position adjusting devices, then the gas flow nozzles are contiguous to the surface of the substrate by adjusting z-axis position adjusting devices, and finally, by adjusting x-axis position adjusting devices, the gas flow nozzles on two sides are symmetric around a center of the plasma welding gun, and it is ensured that the gas flow nozzles are spaced from the plasma welding gun by 5 mm and an included angle between the gas flow nozzles and a horizontal position is 15°;

step 4: the wire feeder and the plasma power source are started to operate under a pre-programmed program to start to perform plasma arc additive manufacturing;

step 5: a CCD camera collects image information of a molten pool and extracts width information of the molten pool in real time. A size D of the molten pool collected by the CCD camera is compared with a preset width Dp of the molten pool; if D>Dp, gas flow output by a gas flow meter increases; if D=Dp, the gas flow output by the gas flow meter does not change; and if D<Dp, the gas flow output by the gas flow meter decreases.

Step 6: one-way cladding deposition is performed as described above, and the thin-wall part with the deposited layer being 4 mm wide is obtained.

What is claimed is:

1. A device for controlling a size of a molten pool in a wire and arc additive manufacturing process, comprising: additive manufacturing equipment, a connecting device and bilateral gas flow devices; wherein
the additive manufacturing equipment comprises a welding gun, a welding power source, a second gas cylinder, a wire feeding device and a wire feeding device connecting plate, wherein welding wires are conveyed to a designed position of a deposited layer by the wire feeding device, molten drops are bonded to a designated substrate under an action of arcs, and a member is formed on the designated substrate by deposition;
a heat source in the wire and arc additive manufacturing process is supplied by the welding power source connected to the welding gun;
the wire feeding device is connected to the connecting device on the welding gun by the wire feeding device connecting plate, so that the welding gun and the wire feeding device move synchronously; and
the bilateral gas flow devices are connected to the connecting device, and precise adjustment of relative positions of the bilateral gas flow devices and the welding gun is achieved by adjusting the connecting device.

2. The device for controlling the size of the molten pool in the wire and arc additive manufacturing process according to claim 1, wherein the connecting device comprises a connecting block, z-axis position adjusting devices, y-axis position adjusting devices, x-axis position adjusting devices and deflection angle position adjusting devices; wherein
the connecting block is fixed to the welding gun, and the connecting block serves as a reference structural member for adjusting the relative positions of the bilateral gas flow devices and the welding gun; and
the welding gun, the connecting block, the z-axis position adjusting devices, the y-axis position adjusting devices, the x-axis position adjusting devices, the deflection angle position adjusting devices and the bilateral gas flow devices are sequentially connected and combined by bolts.

3. The device for controlling the size of the molten pool in the wire and arc additive manufacturing process according to claim 1, wherein an interval between the bilateral gas flow devices is adjusted by adjusting the connecting device, so that a forming size precision of a formed sample piece is controlled; and
in a deposition forming process, bilateral high-speed gas flows apply pressure to side walls of the molten pool to realize a flexible supporting effect on the deposited layer, flow and solidification of the deposited layer are adjusted by changing gas types and temperatures, and precise control over a size of the formed sample piece is achieved.

4. The device for controlling the size of the molten pool in the wire and arc additive manufacturing process according to claim 1, wherein a charge coupled device (CCD) camera is clamped on a rear side of the welding gun and the CCD camera is matched with an optical filter to detect size information of the molten pool; and
a flow controller is adjusted in real time according to the size information of the molten pool detected by the CCD camera to control flow of bilateral high-speed gas flows, and a deformation pressure and a flexible supporting effect applied by the bilateral high-speed gas flows to side walls of the molten pool are changed, so that the size of the molten pool is restrained, and size precision of the formed sample piece is improved.

5. The device for controlling the size of the molten pool in the wire and arc additive manufacturing process according to claim 1, wherein the welding wires are stainless steel welding wires or aluminum alloy welding wires.

6. The device for controlling the size of the molten pool in the wire and arc additive manufacturing process according to claim 1, wherein gases, used for an interior of the welding gun and two sides of the deposited layer, in a first gas cylinder and the second gas cylinder are inert gases.

7. The device for controlling the size of the molten pool in the wire and arc additive manufacturing process according to claim 1, wherein wire and arc additive manufacturing manners comprise gas metal arc welding (GMAW), gas tungsten arc welding (GTAW) and plasma arcs.

8. The device for controlling the size of the molten pool in the wire and arc additive manufacturing process according to claim 2, wherein connecting parts of the z-axis position adjusting devices, the y-axis position adjusting devices, the x-axis position adjusting devices and the deflection angle position adjusting devices are provided with size scales to achieve the precise adjustment of the relative positions of the bilateral gas flow devices and the welding gun.

9. A method for controlling a size of a molten pool in a wire and arc additive manufacturing process implemented by the device for controlling the size of the molten pool in the wire and arc additive manufacturing process according to claim 1, comprising the following steps:
step 1: adjusting the connecting device to allow a horizontal interval between gas flow nozzles of the bilateral gas flow devices to be 1 mm greater than a needed width of the deposited layer and allow an included angle between the gas flow nozzles and a horizontal position to be 15°, and fastening the connecting device after position adjusting to allow the bilateral gas flow devices and the welding gun to keep moving synchronously in a relative position relationship;
step 2: starting the additive manufacturing equipment to be matched with a three-dimensional movement mechanism under a synergistic action of the welding gun, the connecting device and the welding power source for additive manufacturing, adjusting and controlling flow of bilateral high-speed gas flows in real time according to the size of the molten pool detected by the CCD camera in a deposition forming process, changing a deformation pressure and a flexible supporting effect applied by the bilateral high-speed gas flows to side walls of the molten pool to restrain the size of the molten pool, and adjusting flow and solidification of the deposited layer by changing gas types and temperatures;
step 3: returning to an initial position, and lifting the welding gun; and
step 4: repeating step 2 and step 3 for continuous reciprocating deposition, and finally obtaining the member by forming.

10. The method according to claim 9, wherein in the device for controlling the size of the molten pool in the wire and arc additive manufacturing process, the connecting device comprises a connecting block, z-axis position adjusting devices, y-axis position adjusting devices, x-axis position adjusting devices and deflection angle position adjusting devices; wherein
the connecting block is fixed to the welding gun, and the connecting block serves as a reference structural member for adjusting the relative positions of the bilateral gas flow devices and the welding gun; and
the welding gun, the connecting block, the z-axis position adjusting devices, the y-axis position adjusting devices, the x-axis position adjusting devices, the deflection angle position adjusting devices and the bilateral gas flow devices are sequentially connected and combined by bolts.

11. The method according to claim 9, wherein in the device for controlling the size of the molten pool in the wire and arc additive manufacturing process, an interval between the bilateral gas flow devices is adjusted by adjusting the connecting device, so that a forming size precision of a formed sample piece is controlled; and
in a deposition forming process, bilateral high-speed gas flows apply pressure to the side walls of the molten pool to realize the flexible supporting effect on the deposited layer, flow and solidification of the deposited layer are adjusted by changing the gas types and the temperatures, and precise control over a size of the formed sample piece is achieved.

12. The method according to claim 9, wherein in the device for controlling the size of the molten pool in the wire and arc additive manufacturing process, a CCD camera is clamped on a rear side of the welding gun and the CCD camera is matched with an optical filter to detect size information of the molten pool; and
a flow controller is adjusted in real time according to the size information of the molten pool detected by the CCD camera to control the flow of the bilateral high-speed gas flows, and the deformation pressure and the flexible supporting effect applied by the bilateral high-speed gas flows to the side walls of the molten pool are changed, so that the size of the molten pool is restrained, and size precision of the formed sample piece is improved.

13. The method according to claim 9, wherein in the device for controlling the size of the molten pool in the wire and arc additive manufacturing process, the welding wires are stainless steel welding wires or aluminum alloy welding wires.

14. The method according to claim 9, wherein in the device for controlling the size of the molten pool in the wire and arc additive manufacturing process, gases, used for an interior of the welding gun and two sides of the deposited layer, in a first gas cylinder and the second gas cylinder are inert gases.

15. The method according to claim 9, wherein in the device for controlling the size of the molten pool in the wire and arc additive manufacturing process, wire and arc additive manufacturing manners comprise GMAW, GTAW and plasma arcs.

16. The method according to claim 10, wherein in the device for controlling the size of the molten pool in the wire and arc additive manufacturing process, connecting parts of the z-axis position adjusting devices, the y-axis position adjusting devices, the x-axis position adjusting devices and the deflection angle position adjusting devices are provided with size scales to achieve precise adjustment of the relative positions of the bilateral gas flow devices and the welding gun.
